(19) United States
(12) Patent Application Publication
(10) Pub. No.: US 2026/0100882 A1
(43) Pub. Date: Apr. 9, 2026

(54) SYSTEMS AND METHODS FOR INTERNET-ON-DEMAND (IOD) SERVICES MANAGEMENT

(71) Applicant: CenturyLink Intellectual Property LLC, Denver, CO (US)

(72) Inventor: Jacob JOHANSEN, Sammamish, WA (US)

(73) Assignee: CenturyLink Intellectual Property LLC, Denver, CO (US)

(21) Appl. No.: 19/329,414

(22) Filed: Sep. 15, 2025

Related U.S. Application Data
(60) Provisional application No. 63/704,351, filed on Oct. 7, 2024.

(51) Int. Cl. H04L 41/0896; H04L 41/0823; H04L 41/5022; H04L 43/04

(52) U.S. Cl. CPC H04L 41/0896; H04L 41/0823; H04L 41/5022; H04L 43/04

(57) ABSTRACT

Disclosed are systems and methods that provide a novel framework for automatically and/or dynamically managing and controlling Internet-on-Demand (IoD) services and connected devices therefrom. The disclosed framework can operate to adjust network configurations, parameters, and/or some combination thereof, to provide IoD services and associated mechanics for connected devices (and/or networks) to be utilized for spatially and/or temporally-based, optimized network connectivity. The framework operates to monitor for events (e.g., from third party applications, for example), and based therefrom, determine a priority for associated services such that a corresponding network can be configured to priority network parameters to the more critical networked services.

### CROSS-REFERENCE TO RELATED APPLICATIONS

This application claims priority from U.S. Provisional Patent Application No. 63/704,351, filed on Oct. 7, 2024, which is incorporated herein by reference in its entirety.

### FIELD OF THE DISCLOSURE

The present disclosure is generally related to a network management, and more particularly, to a decision intelligence (DI)-based computerized framework for automatically and/or dynamically managing and controlling Internet-on-Demand (IoD) services and connected devices therefrom.

### SUMMARY OF THE DISCLOSURE

According to some embodiments, as discussed herein, the disclosed systems and methods provide a novel computerized IoD framework that can operate to dynamically and automatically adjust network configurations, parameters, and/or some combination thereof, to provide IoD services and associated mechanics for connected devices (and/or networks, for example Wireless Fidelity (WiFi or Wi-Fi, used interchangeably)) to be utilized for spatially and/or temporally-based, optimized network connectivity.

According to some embodiments, IoD services can achieve near-instantaneous delivery through a combination of advanced technologies, sophisticated infrastructure and efficient operational strategies. Such complex ecosystems can operate seamlessly to provide users with immediate access to content, products and services. As discussed herein, IoD services can significantly optimize network connectivity for scheduled events, benefiting both users and devices. Such optimization can be crucial in scenarios where predictable surges in network demand occur, such as during live-streamed concerts, major sporting events, or scheduled software updates for connected devices. By leveraging IoD services, network providers can dynamically allocate bandwidth and resources in anticipation of these scheduled events.

As discussed herein, such proactive approach can ensure that the network infrastructure is prepared to handle the increased load, minimizing latency and service disruptions. For example, a streaming platform hosting a popular live event can use IoD to temporarily boost its server capacity and content delivery network (CDN) performance in specific geographic areas where high viewership is expected.

Moreover, as evident from the discussion herein, IoD services can enable more efficient use of network resources outside of peak times. Instead of maintaining constant high-capacity infrastructure, providers can scale their services up or down based on predicted demand. This not only optimizes costs but also allows for better overall network performance. During off-peak hours, freed-up resources can be reallocated to maintenance tasks, system updates, or to support other services.

In some embodiments, for users (which can be a person, group of people, an organization, entity, and the like), the disclosed IoD optimization can translate to a smoother, more reliable experience during high-demand events. For example, viewers streaming a live sports match can experience fewer buffering issues and higher video quality. Similarly, businesses conducting large-scale video conferences or virtual events can ensure that all participants have stable connections and clear audio/video feeds.

On the device side, operations provided via functionality of the disclosed systems and methods can provide IoD services that can coordinate scheduled updates or data syncs to occur during periods of lower network congestion. This is particularly valuable for Internet of Things (IoT) devices, which often need to transmit data or receive updates in large numbers. By scheduling these activities during off-peak hours and staggering them across different device groups, network load is distributed more evenly, preventing system-wide slowdowns.

Moreover, IoD services can implement smart queuing systems for large file transfers and/or updates. That is, for example, instead of all devices attempting to download updates simultaneously, the disclosed framework can prioritize and schedule downloads based on factors such as, for example, network connectivity, device criticality, battery life, user preferences, and the like. Accordingly, this can ensure that essential updates are completed promptly while less critical ones are deferred to more opportune times.

In some embodiments, the adaptability of IoD services also allows for real-time adjustments based on unforeseen circumstances. For example, if an unexpected event causes a spike in network usage, the disclosed framework can operate to reallocate resources from less critical services to maintain performance for priority tasks. Such dynamic resource management ensures that the network remains resilient and responsive even in unpredictable scenarios.

In some embodiments, as discussed herein, IoD optimization can extend to edge computing environments, where data processing occurs closer to the source rather than in centralized data centers. For example, for scheduled events that require low latency, such as augmented reality experiences at live venues, IoD services can temporarily boost edge computing capabilities in specific locations. Such localized enhancement can ensure that data is processed and delivered with minimal delay, crucial for real-time interactive experiences.

Accordingly, as discussed herein and in more detail below, the disclosed framework can operate to provide a powerful toolkit for optimizing network connectivity around scheduled events. By intelligently managing resources, predicting demand and dynamically adjusting network configurations, the disclosed framework can function to provide capabilities for both users and devices to experience optimal performance during high-demand periods while maintaining efficient resource utilization overall. Thus, the disclosed framework provides a smart, flexible approach to network management, which is vital in today's hyper-connected world, where the demand for seamless, high-quality digital experiences continues to grow and relied on by business, organizations and individuals alike.

According to some embodiments, a method is disclosed for a DI-based computerized framework for automatically and/or dynamically managing and controlling IoD services and connected devices therefrom. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for automatically and/or dynamically managing and controlling IoD services and connected devices therefrom.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4A illustrates an exemplary workflow according to some embodiments of the present disclosure;

FIG. 4B illustrates non-limiting example embodiments according to some embodiments of the present disclosure;

FIG. 5 depicts an exemplary implementation of an architecture according to some embodiments of the present disclosure;

FIG. 6 depicts an exemplary implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, as discussed herein, the disclosed framework provides novel functionalities and capabilities for optimizing IoD services for scheduled events via integration of advanced technologies and data-driven approaches to ensure efficient resource allocation and high-quality service delivery. As discussed herein, the disclosed framework can employ artificial intelligence/machine learning (AI/ML) algorithms to analyze historical service consumption patterns and correlate them with past business events. Such predictive modelling can form the foundation for anticipating future bandwidth requirements, allowing for proactive resource allocation. To enhance the framework's decision-making capabilities, a large language model (LLM) (e.g., natural language processing (NLP) model, for example) component can be incorporated to analyze event descriptions and related content, whereby the LLM can rank events based on their determined (and/or predicted) importance and/or potential impact on network resources, considering factors such as, but not limited to, keywords indicating event significance, sentiment analysis, named entity recognition, and the like, to identify key participants and/or stakeholders.

According to some embodiments, as provided herein, the disclosed framework can operate to refine its prioritization and resource allocation strategies by integrating relevant business intelligence data. This, for example, can include, but is not limited to, historical service consumption for similar events, billing information to identify high-value clients or locations, customer service level agreements (SLAs) with their specific requirements, and the like, or some combination thereof. By considering such business factors, the framework can perform informed decisions that align with organizational priorities and contractual obligations.

Accordingly, as discussed herein, the disclosed framework can provide and/or effectuate a dynamic resource reservation system that can be implemented to automatically allocate bandwidth and computing resources based on the predictions and prioritizations for users, events, and the like, or some combination thereof, which are designed to be flexible and capable of adapting to changing circumstances in real-time.

According to some embodiments, security and compliance components and/or instructions can be integrated into the framework's operations via robust, computationally effectuated measures implemented to protect sensitive business data used in the optimization process. For example, this can include, but is not limited to, end-to-end encryption, access control mechanisms, and audit trails to ensure compliance with data protection regulations and industry standards, and the like. Indeed, the framework can be configured to integrate seamlessly with external systems through application program interfaces (APIs) and connectors, for example, as discussed below. Such configuration, for example, can enable interaction with third party systems, which can include, but are not limited to, calendar and event management systems, network monitoring tools, customer relationship management (CRM) systems, billing platforms, and the like, thereby providing functionality for ensuring that the IoD optimization processes are fully integrated into the broader technological ecosystem of an organization and/or supported region.

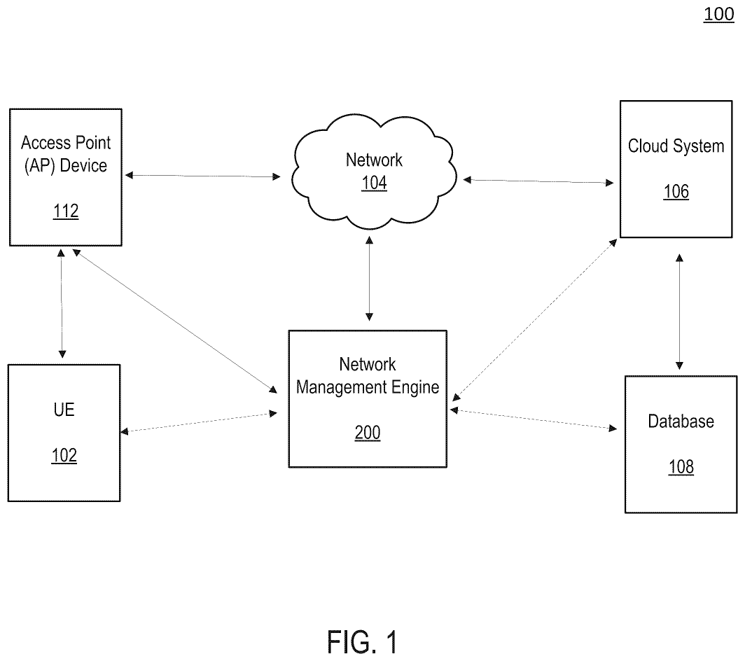

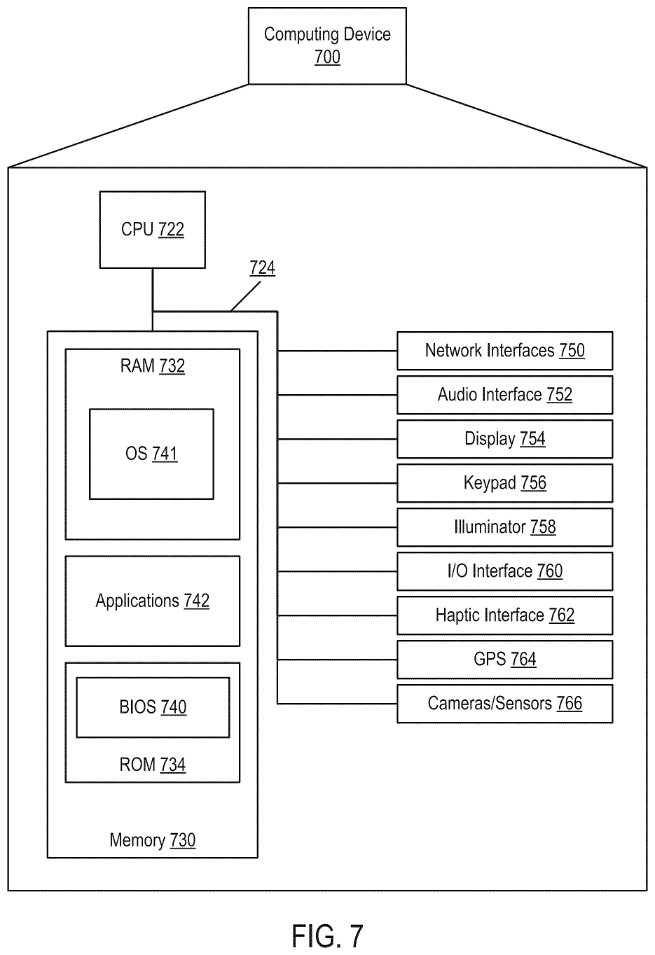

With reference to FIG. 1, system 100 is depicted which includes user equipment (UE) 102 (e.g., a client device, as mentioned above and discussed below in relation to FIG. 7), access point (AP) device 112, network 104, cloud system 106, database 108 and network management engine 200. It should be understood that while system 100 is depicted as including such components, it should not be construed as limiting, as one of ordinary skill in the art would readily understand that varying numbers of UEs, AP devices, peripheral devices, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, autonomous machine, and any other device equipped with a cellular or wireless or wired transceiver. For example, UE 102 can be a smart phone with applications installed and/or accessible thereon. In another non-limiting example, UE 102 can correspond to a laptop of an employee of an organization that has an Internet Service Provider (ISP) and/or communication service provider (CSP) account with an ISP/CSP provider.

In some embodiments, a peripheral device (not shown) can be connected to UE 102, and can be any type of peripheral device, such as, but not limited to, a wearable device (e.g., smart ring or smart watch), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like. For example, the peripheral device can be a smart phone, smart ring, smart watch or other wearable device that connectively pairs with UE 102, which is a user's laptop.

According to some embodiments, AP device 112 is a device that creates a wireless local area network (WLAN) for the location. According to some embodiments, the AP device 112 can be, but is not limited to, a router, switch, hub and/or any other type of network hardware that can project a WiFi signal to a designated area. In some embodiments, UE 102 may be an AP device.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider, which has associated network resources hosted on the internet or private network (e.g., network 104), which enables (via engine 200) the sleep management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, and the services and applications provided by cloud system 106 and/or network management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

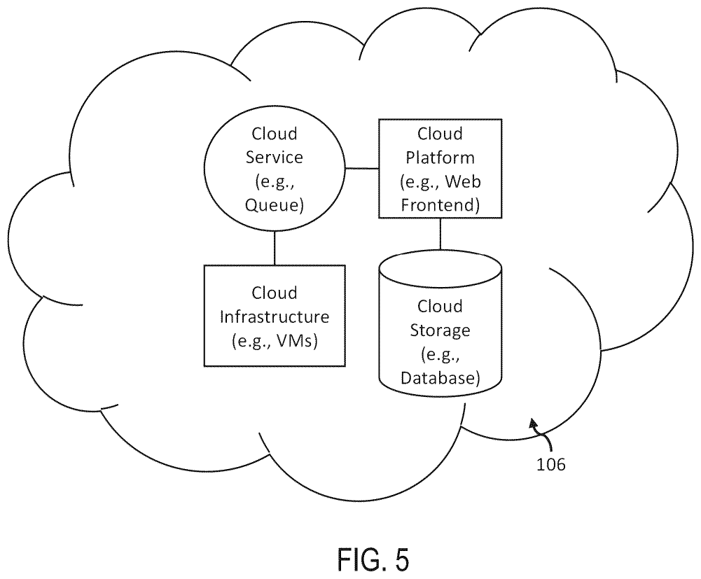

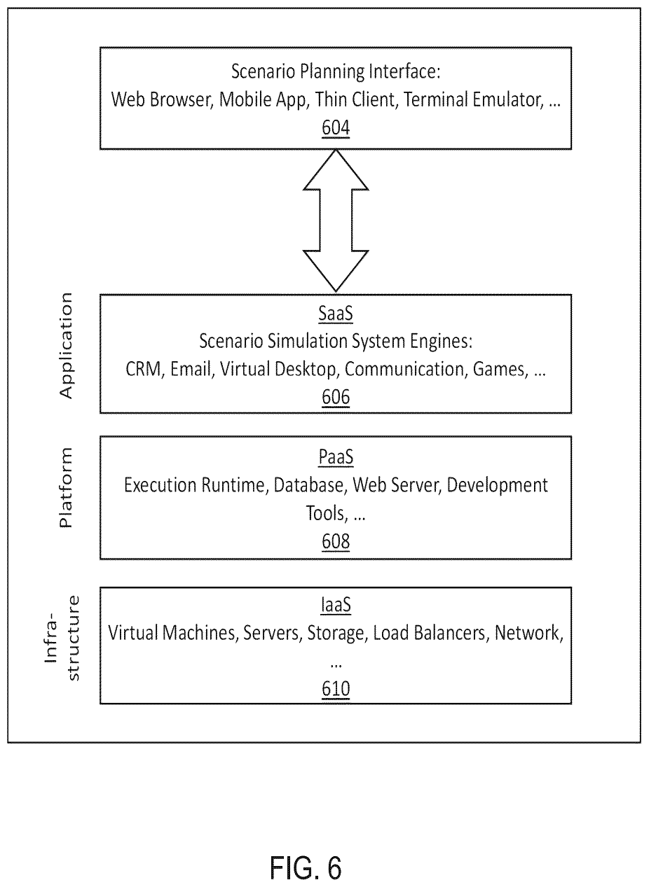

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 610, platform as a service (PaaS) 608, and/or software as a service (SaaS) 606 using a web browser, mobile app, thin client, terminal emulator or other endpoint 604. In some embodiments, the architecture can also be network as a service (Naas). FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository

Network management engine 200, as discussed above and further below in more detail, can include components for the disclosed functionality. According to some embodiments, network management engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

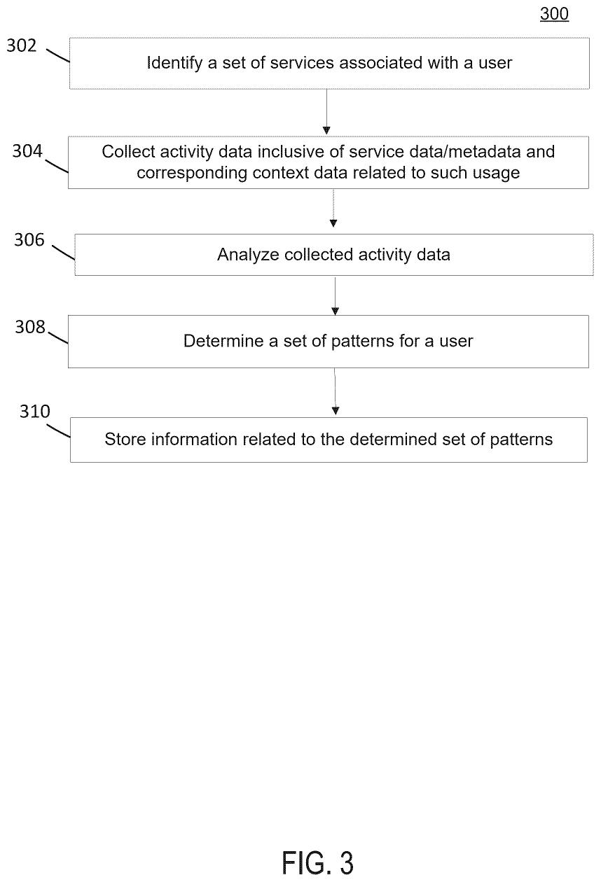

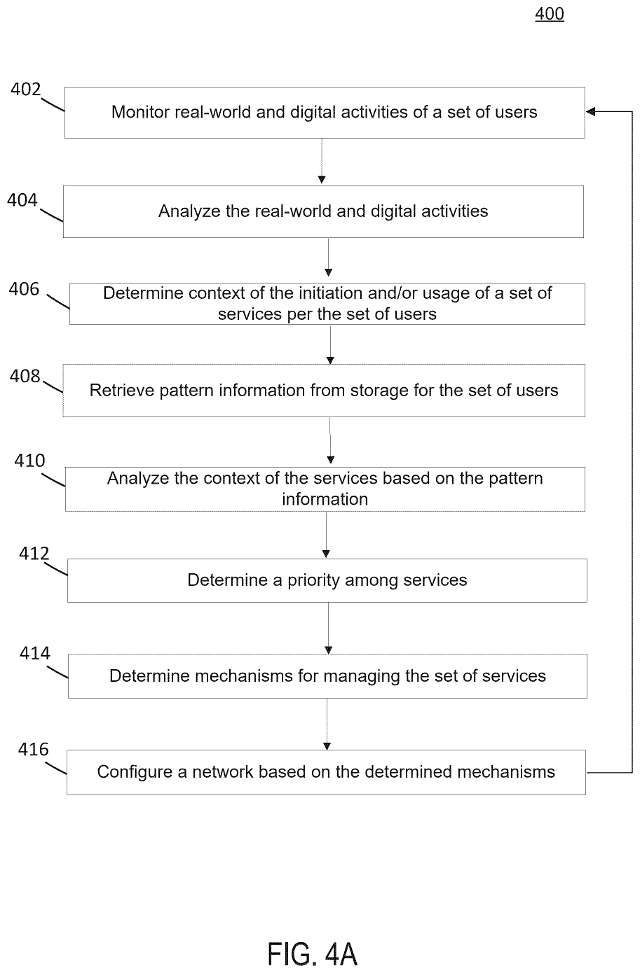

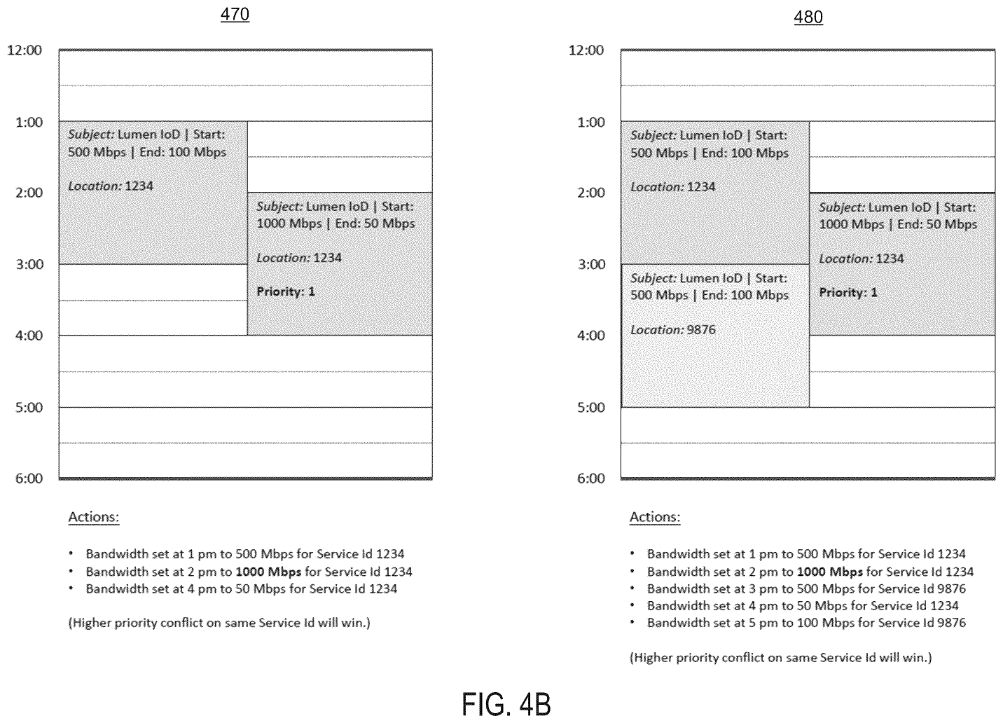

According to some embodiments, as discussed in more detail below, network management engine 200 may be configured to implement and/or control a plurality of services and/or microservices, where each of the plurality of services/microservices are configured to execute a plurality of workflows associated with performing the disclosed security management. Non-limiting embodiments of such workflows are provided below in relation to at least FIGS. 3-4.

According to some embodiments, as discussed above, network management engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102 (and/or AP device 112, in some embodiments). In some embodiments, such application may be a web-based application accessed by AP device 112, UE 102 and/or other devices over network 104 from cloud system 106. In some embodiments, engine 200 may be configured and/or installed as an augmenting script, program or application (e.g., a plug-in or extension) to another application or program provided by cloud system 106 and/or executing on AP device 112 and/or UE 102.

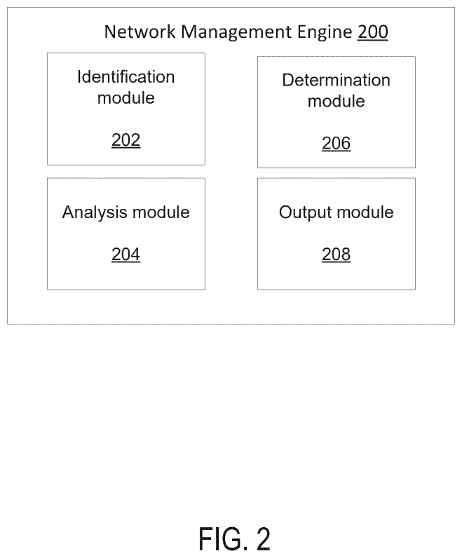

As illustrated in FIG. 2, according to some embodiments, network management engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for the disclosed network management framework. According to some embodiments, Process 300 provides non-limiting embodiments for determining contextual user information related to how services (e.g., applications, activities, and the like) are used and/or interacted with, and leveraging such information to determine corresponding patterns of behavior for which the disclosed framework (e.g., via network management engine 200) can control, manage and manipulate the operational status such applications based therefrom. As discussed below at least in relation to Process 400 of FIG. 4A, respectively, the leveraged and stored information can be utilized to optimize, control, manage, allow and/or prevent such service usage/interactions.

It should be understood that while the discussion herein will be with reference to a service(s) being executed and/or performed via a device, it should not be construed as limiting, as any type of application, program, website, network resource, platform or device (e.g., any of the UEs discussed above) can form the basis of determining patterns of activity, as discussed herein, without departing from the scope of the instant disclosure.

According to some embodiments, Steps 302-304 of Process 300 can be performed by identification module 202 of network management engine 200; Step 306 can be performed by analysis module 204; Step 308 can be performed by determination module 204; and Step 310 can be performed by output module 208.

According to some embodiments, Process 300 begins with Step 302 where a set of services associated with a user are identified. For purposes of this discussion, reference to a user will be utilized to discuss operated, scheduled and/or requested services, and it should be understood that a user can be any type of real-world entity (RWE) that can interact with a network and/or resources over such network (e.g., and has a user account, for example). For example, a user can be, but is not limited to, a person, group of people, organization, company, department, and the like. Indeed, while the discussion herein may focus on a single user, such discussion is for clarity purposes as the operations of Process 300 (and Processes 400 and 450, discussed infra) can be utilized for a plurality of users in a similar manner without departing from the scope of the instant disclosure.

Such services, which can correspond to application accounts (e.g., calendar of third party providers, for example) can correspond to accounts of a user(s) that enable the usage of an application(s) and/or application program interface (API). According to some embodiments, the service accounts can include information related to, but not limited to, user identifier (ID), username/password or other login credentials (e.g., biometrics), user demographics, location, device ID, application ID, service set identifier (SSID) for a connected network, and the like, or some combination thereof.

As discussed herein, reference to an application of a service, for example, can include any type of known or to be known computer-executable program or software-backed API that can be access, hosted, stored and/or executed by UE 102 (e.g., apps installed on UE 102 and/or accessed by UE 102 via network 104)—for example, calendar applications, social media applications, messaging applications (e.g., email, SMS, MMS), health applications, news applications, calendar applications, and the like. For purposes of this disclosure, without limiting the scope of the instant disclosure, a calendar application will be used as reference (see FIG. 4B, discussed infra); however, it should not be construed as limiting as other types of applications (e.g., electronic mail, for example) can be utilized without departing from the scope of the instant disclosure.

Accordingly, Step 302 can involve engine 200 identifying information related to an application or set of applications associated with a device and/or set of devices associated with a user, whereby such information can correspond to, but not be limited to, a time of usage, location of usage (e.g., which network resources are accessed and/or what the corresponding device's GPS coordinates during such usage, for example), type and/or activity involved in such usage, type and/or ID of application, type and/or ID of device, ID of a network (e.g., which WiFi network is connected to, for example) and the like, or some combination thereof.

In Step 304, engine 200 can operate to trigger the identified devices to collect data about the application (e.g., referred to as activity data). According to some embodiments, the activity data can be collected continuously and/or according to a predetermined period of time or interval. In some embodiments, activity data may be collected based on detected events. In some embodiments, type and/or quantity of user data may be directly tied to the type of application and/or device performing such activity data collection. For example, a start time of a calendar event (or a time proximate to such start time, for example—5 minutes before) can trigger the collection of services related to a scheduled event, as discussed herein.

In some embodiments, such activity data may be derived and/or mined from stored activity data within an associated datastore or cloud. For example, engine 200 can be associated with a cloud, which can store collected network traffic and/or collected activity data for the user in an associated account of the user. Thus, in some embodiments, Step 304 can involve querying the cloud for information about the user, which can be based on a criteria that can include, but is not limited to, a time, date, location, activity, event, application ID/type, other collected user data, and the like, or some combination thereof.

In some embodiments, the collected activity data in Step 304 can be stored in database 108 in association with ID of a user, ID of the application, ID of the device, ID of the location and/or an ID of an account of the user/location, and the like.

In Step 306, engine 200 can analyze the collected activity data. According to some embodiments, engine 200 can implement any type of known or to be known computational analysis technique, algorithm, mechanism or technology to analyze the collected activity data from Step 306.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may leverage a large language model (LLM), whether known or to be known. An LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the user data, as discussed herein.

According to some embodiments, the AI/ML and LLM computational analysis algorithms implemented can be applied and/or executed in a time-based manner, in that collected user data for specific time periods can be allocated to such time periods so as to determine patterns of activity (or non-activity) according to a criteria. For example, engine 200 can execute a Bayesian determination for a predetermined time span, at preset intervals (e.g., a 24 hour time span, every 8 hours, for example) and/or at certain locations (e.g., at work, the store, home, in the car, and the like), so as to segment the day according to applicable time-and/or location-based patterns, which can be leveraged to determine, derive, extract or otherwise identify activities/non-activities in/around a location(s) (e.g., what services are an entity operating during the workday, for example).

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 308, based on the analysis from Step 306, engine 200 can determine a set of patterns for a user(s) (and/or patterns for the service(s)/application(s)). According to some embodiments, the determined patterns are based on the computational AI/ML analysis performed via engine 200, as discussed above.

In some embodiments, the set of patterns can correspond to, but are not limited to, types of events, types of detected activity, a time of day, a date, location, type of user, duration, amount of activity, quantity of activities, type and/or identify of connected network (e.g., cellular versus WiFi, for example), and the like, or some combination thereof. Accordingly, the patterns can be specific to, but not limited to, a user, an application, a device, a network, and/or specific to the location, and the like, or some combination thereof.

Thus, according to some embodiments, Step 308 can involve engine 200 determining a set of activity patterns for the user's usage of a service(s) based on the activity data, which as discussed below at least in relation to Process 400 of FIG. 4A, can be utilized to generate and/or execute mechanisms for controlling how, when and/or where such services can be used by the user.

In Step 310, engine 200 can store the determined set of patterns in database 108, in a similar manner as discussed above. According to some embodiments, Step 310 can involve creating a data structure associated with each determined pattern, whereby each data structure can be stored in a proper storage location associated with an ID of the user/application/device/location, as discussed above.

In some embodiments, a pattern can comprise a set of events, which can correspond to an activity and/or non-activity (e.g., sending messages, watching media, typing, scrolling, downloading, uploading, and the like, for example). In some embodiments, the pattern's data structure can be configured with header (or metadata) that identifies a user, application, device and/or the location, and a location and/or a time period/interval of analysis (as discussed above); and the remaining portion of the structure providing the data of the activity/non-activity and status of such activities during such sequence(s). In some embodiments, the data structure for a pattern can be relational, in that the events of a pattern can be sequentially ordered, and/or weighted so that the order corresponds to events with more or less activity.

In some embodiments, the structure of the data structure for a pattern can enable a more computationally efficient (e.g., faster) search of the pattern to determine if later detected events correspond to the events of the pattern, as discussed below in relation to at least Processes 400 and/or 450. In some embodiments, the data structures of patterns can be, but are not limited to, files, arrays, lists, binary, heaps, hashes, tables, trees, and the like, and/or any other type of known or to be known tangible, storable digital asset, item and/or object.

According to some embodiments, the activity data can be identified and analyzed in a raw format, whereby upon a determination of the pattern, the data can be compiled into refined data (e.g., a format capable of being stored in and read from database 108). Thus, in some embodiments, Step 310 can involve the creation and/or modification (e.g., transformation) of the activity data into a storable format.

In some embodiments, as discussed below, each pattern (and corresponding data structure) can be modified based on further detected behavior, as discussed below in relation to Process 400 of FIG. 4A.

Turning to FIG. 4A, Process 400 provides non-limiting example embodiments for the deployment and/or implementation of the disclosed network control framework. According to some embodiments, Steps 402 and 408 of Process 400 can be performed by identification module 202 of network management engine 200; Steps 404 and 410 can be performed by analysis module 204; Steps 406, 412 and 414 can be performed by determination module 206; and Step 416 can be performed by output module 208.

According to some embodiments, Process 400 begins with Step 402 where engine 200 can monitor a device(s) of a set of users to detect, determine or otherwise identify real-world and/or digital activities of the set of users. For example, the set of users can be employees for a company. In another non-limiting example, the set of users can be companies in a specific geographic region (e.g., a city, for example).

In some embodiments, such activities can correspond to, but are not limited to, network resource access and download requests, website visits, application initiations and/or engagements, device usage, network connectivity, and the like, or some combination thereof. In some embodiments, such activities can also provide real-world information, which can include, but are not limited to, user IDs, location IDs, time periods, times and the like. For example, such activity can be the occurrence of a calendar invite coming due on a user's calendar (e.g., it is 3 PM on Wednesday, Jan. 1, 2025, and the user has a scheduled Zoom meeting with their supervisor to go over 2025 projections). Thus, the information for such activities can be collected, analyzed and extracted from applications, data structures, files, items, and/or other digital information collectable by a user's device and/or over a network.

In some embodiments, Step 402 can involve engine 200 monitoring a network, the devices (of the set of users) and/or activities related to the user/device according to a criteria, which can correspond to, but not be limited to, predetermined time interval and/or upon detection of an event (e.g., SSID identification/connection, application launch request, arrival at a specific location, and the like) and/or continuously. For example, upon a scheduled training for a new product for a user at work (e.g., via the user's device connecting to the work WiFi network), Step 402 can be triggered.

In Step 404, based on the monitoring of the location, engine 200 can analyze the monitored real-world and/or digital activities (and corresponding collected data based therefrom), which can be performed in a similar manner as discussed above at least in relation to Step 306.

In Step 406, engine 200 can determine a context for each service's initiation. For example, in Step 402, engine 200 detects that the user is requesting access to an application (e.g., provides a touch input on their smart phone indicating a desire to open an application according to a scheduled calendar event). In Step 402, engine 200 can further identify/determine information related to the request, which can include, but is not limited to, time, date, location, user ID, device ID, device type, application type, application ID, and the like, or some combination thereof.

Thus, in Step 404, information related to the set of users' activities (which can include the set of services) can be analyzed, whereby in Step 406, engine 200 can determine a context of the application's usage, which can be performed for each user in the set of users, and/or each service in the set of services.

According to some embodiments, the context can include information related to, but not limited to, an intent of the user for the application (e.g., if it's a social application, then social intentions; if a CAD program, then since the user is an architect, this would be for business purposes, for example), a time, location, and the like. Thus, in some embodiments, the context can provide temporal and/or spatial data related to the usage, which correlates to an intention as defined by where the user is at certain times/dates.

In Step 408, engine 200 can retrieve application pattern information from storage (as per Step 310, discuss supra). In some embodiments, such retrieval can be based on, but not limited to, a time, date, user ID, application ID, context, device ID, network ID, and the like, or some combination thereof. For example, if the context (from Step 406) corresponds to a user at work on a Monday, then a pattern for the user's application usage patterns on Monday at work can be retrieved.

In Step 410, engine 200 can analyze the context of the services'usage based on the application pattern information for each user/services (from Step 406). Such computational analysis can be performed in a similar manner as discussed above respective to the AI/ML model applications in Steps 404 and Step 306.

In some embodiments, such analysis can involve parsing the text of an event (of a calendar, application, for example), where the text can be, but is not limited to, the subject line, body and/or metadata. In some embodiments, engine 200 can parse the events associated with the services in the set of services, and extract text based content for which the AI/ML and/or LLM-based analysis can be performed.

In Step 412, engine 200 can determine a priority among the services from the set of services for the set of users. For example, if user X is requesting service A, and user Y needs service B, then engine 200, based on the analysis in Step 410 can determine a priority among such services. Such priority can account for, but not be limited to, type of service, user ID, hierarchy among the users, start time of the service and/or end time of the service (as per the calendar appointment), amount of resources required for the service (e.g., bandwidth, latency, throughput, and the like), and the like, or some combination thereof. Thus, engine 200 can perform the AI/ML and/or LLM-based analysis discussed above to perform such priority determination.

By way of non-limiting examples, FIG. 4B depicts examples 470 and 480 which illustrate how and why certain events are prioritized over others, which can be determined via the above mechanisms performed via engine 200. Thus, for example, the provided “Actions” in examples 470 and 480 provide priority determinations (as per Step 412, discussed supra), and network configuration (e.g., bandwidth) configurations (as per Steps 414 and 416, discussed infra).

In Step 414, engine 200 can, based on the analysis from Step 410 and priority determination from Step 412, determine which mechanisms can be defined, implemented and/or provided for the management and control of the services on the network. According to some embodiments, the mechanisms can be configured as executable files and/or data structures that enable the operations of specifically configured capabilities and/or functionalities (e.g., via engine 200) to control, manipulate and/or manage how a service can function on the network. In some embodiments, such mechanisms can involve management of, but not limited to, the network - for example, allocate, limit, throttle and/or increase bandwidth for the device/application of the user.

Accordingly, in some embodiments, based on the determined mechanisms, in Step 416, engine 200 can implement them which can provide controls and/or modifications to the manner the network is provided and/or its configuration (and/or topology, for example). Thus, according to some embodiments, engine 200 can dynamically modify network parameters, such as bandwidth, for specific services through a sophisticated combination of technologies and methodologies.

According to some embodiments, engine 200 can operate Software-Defined Networking (SDN) operations via Steps 414 and 416, which involves engine 200 separating the network's control plane from the data plane, enabling centralized management and real-time programmability of network resources. This allows engine 200 to reconfigure network paths and allocate resources dynamically based on service priorities and demands. In some embodiments, engine 200 can implement network slicing, which leverages Network Function Virtualization (NFV) to create multiple virtual networks atop shared physical infrastructure, each optimized for specific services or applications.

In some embodiments, engine 200 can implement and adjust Quality of Service (QoS) policies on the fly, modifying parameters such as, but not limited to, bandwidth allocation, traffic prioritization, latency requirements, and the like, to ensure optimal performance for different services. Dynamic bandwidth allocation, driven by predictive analytics and real-time monitoring, allows engine 200 to adjust resource distribution as needed, such as temporarily increasing bandwidth for software update rollouts. Traffic shaping and policing techniques can be employed to control data flow speeds and enforce bandwidth limits, managing congestion and ensuring fair resource distribution among services.

In some embodiments, for content-heavy services, engine 200 can integrate with Content Delivery Networks (CDNs), dynamically adjusting configurations like activating additional edge nodes or modifying caching policies to optimize content delivery. Application-aware networking enables engine 200 to recognize specific services and apply tailored optimizations, such as minimizing jitter for video conferencing applications. In streaming scenarios, engine 200 can operate in conjunction with adaptive bitrate technologies to dynamically adjust content quality based on available bandwidth.

In some embodiments, engine 200 can implement load balancing configurations to dynamically adjust network traffic (per device and/or node, for example) to distribute traffic across multiple servers or network paths, thereby optimizing resource utilization for high-demand services. In some embodiments, engine 200 can expose APIs that enable services to request specific network configurations, such as increased bandwidth allocation before a scheduled live event.

Accordingly, after Step 416, engine 200 may then continue monitoring the network, which can continue running in the backend, while certain modules of engine 200 execute to maintain the network management framework for ongoing and/or to-be received service requests. In some embodiments, upon execution of Step 416, engine 200 can utilize the information derived from Process 400 (e.g., the determine mechanisms, real-world and/or digital activities, determined context, priority determinations, and the like, or some combination thereof) to further train the models utilized for processing, which as discussed above, can be any of the AI/ML and/or LLMs discussed supra. Accordingly, upon completion of the processing of Process 400, engine 200 can recursively proceed back to Step 402, where monitoring of activities of the user can proceed, and further a trained model(s) can be applied for further network configuration.

Thus, as provided above, engine 200 can provide an orchestration layer to existing networks that can integrate with existing real-time network telemetry, service-level agreements, business priorities and predictive analytics, for example, which can operate to continuously monitor network conditions and service demands, and perform informed decisions on resource allocation and configuration across various services. By leveraging these technologies and methodologies, engine 200 can ensure optimal performance, efficient resource utilization and improved user experiences across a diverse range of applications and use cases, dynamically adapting the network to meet the ever-changing demands of modern digital services.

FIG. 7 is a schematic diagram illustrating a client device showing an example embodiment of a client device that may be used within the present disclosure. Client device 700 may include many more or less components than those shown in FIG. 7. However, the components shown are sufficient to disclose an illustrative embodiment for implementing the present disclosure. Client device 700 may represent, for example, UE 102 discussed above at least in relation to FIG. 1.

As shown in the figure, in some embodiments, Client device 700 includes a processing unit (CPU) 722 in communication with a mass memory 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device 700 may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying a set of services, each of the set of services corresponding to a time, each of the set of services being executable over a network;
analyzing information related to the set of services;
determining, based on the analysis, a priority for the set of services;
determining, based further on the analysis and on the determined priority, a network configuration for the network; and
performing configuration operations on the network based on the determined network configuration.

2. The method of claim 1, further comprising:
determining bandwidth values for each of the set of services, the bandwidth determinations being based on the determined priority; and
performing the network configuration determination based on the bandwidth determinations.

3. The method of claim 1, further comprising:
retrieving a pattern associated with the time for each of the set of services, the pattern indicating a type of network activity of an associated user for each respective service;
performing the analysis of the information related to the set of services based on the retrieved pattern; and
determining the network configuration based further on the performed analysis based on the retrieved pattern.

4. The method of claim 3, further comprising:
collecting activity data on the network related to the set of services, the activity data corresponding to prior instances of each service's execution on the network; and
determining a set of patterns based on analysis of the collected activity data, wherein the retrieved pattern is selected from the determined set of patterns.

5. The method of claim 1, further comprising:
determining a context for each of the set of services based on the analysis of the information related to the set of services; and
determining the priority based on the determined context.

6. The method of claim 1, further comprising:
identifying an event for each of the set of services, each event providing information related to the time and text content indicating a respective service, wherein the information related to the set of services corresponds to a respective event for each service in the set of services.

7. The method of claim 6, further comprising analyzing each respective event via execution of a large language model (LLM).

8. The method of claim 1, further comprising the set of services being related to a set of users.

9. The method of claim 1, further comprising the set of services being executable applications.

10. The method of claim 1, further comprising the determined network configuration comprising a set bandwidth and set time for execution of each of the set of services.

11. A system comprising:
a processor configured to:
identify a set of services, each of the set of services corresponding to a time, each of the set of services being executable over a network;
analyze information related to the set of services;
determine, based on the analysis, a priority for the set of services;
determine, based further on the analysis and on the determined priority, a network configuration for the network; and
perform configuration operations on the network based on the determined network configuration.

12. The system of claim 11, wherein the processor is further configured to:
determine bandwidth values for each of the set of services, the bandwidth determinations being based on the determined priority; and
perform the network configuration determination based on the bandwidth determinations.

13. The system of claim 11, wherein the processor is further configured to:
retrieve a pattern associated with the time for each of the set of services, the pattern indicating a type of network activity of an associated user for each respective service;
perform the analysis of the information related to the set of services based on the retrieved pattern; and
determine the network configuration based further on the performed analysis based on the retrieved pattern.

14. The system of claim 11, wherein the processor is further configured to:
determine a context for each of the set of services based on the analysis of the information related to the set of services; and
determine the priority based on the determined context.

15. The system of claim 11, wherein the processor is further configured to:
identify an event for each of the set of services, each event providing information related to the time and text content indicating a respective service, wherein the information related to the set of services corresponds to a respective event for each service in the set of services.

16. The system of claim 11, wherein the processor is further configured such that the set of services are related to a set of users.

17. The system of claim 11, wherein the processor is further configured such that the determined network configuration comprises a set bandwidth and set time for execution of each of the set of services.

18. A non-transitory computer-readable storage medium tangibly encoded with computer-executable instructions that when executed by a processor, perform a method comprising:
identifying a set of services, each of the set of services corresponding to a time, each of the set of services being executable over a network;
analyzing information related to the set of services;
determining, based on the analysis, a priority for the set of services;
determining, based further on the analysis and on the determined priority, a network configuration for the network; and
performing configuration operations on the network based on the determined network configuration.

19. The non-transitory computer-readable storage medium of claim 18, further comprising:
determining bandwidth values for each of the set of services, the bandwidth determinations being based on the determined priority; and
performing the network configuration determination based on the bandwidth determinations.

20. The non-transitory computer-readable storage medium of claim 18, further comprising:
retrieving a pattern associated with the time for each of the set of services, the pattern indicating a type of network activity of an associated user for each respective service;
performing the analysis of the information related to the set of services based on the retrieved pattern; and
determining the network configuration based further on the performed analysis based on the retrieved pattern.
